(19) United States
(12) Patent Application Publication
(10) Pub. No.: US 2003/0115908 A1
(43) Pub. Date: Jun. 26, 2003

(54) Method for offline collapsing a preform

(76) Inventors: Wolfgang Hammerle, Jena (DE); Jorg Kotzing, Jena (DE); Mohd A. Aslami, Sturbridge, MA (US)

Correspondence Address: PATTON BOGGS LLP, 2550 M Street, NW, Washington, DC, 20037-1350, US

(21) Appl. No.: 10/193,197

(22) Filed: Jul. 11, 2002

Related U.S. Application Data
(60) Provisional application No. 60/341,749, filed on Dec. 21, 2001.

(51) Int. Cl. C03B 37/018; C03B 37/07

(52) U.S. Cl. 65/379; 65/418; 65/419; 65/391; 65/420

(57) ABSTRACT

A method and apparatus for making optical fiber preforms using modified chemical vapor deposition (MCVD) A starting tubular member is installed on a chemical vapor deposition apparatus and, using MCVD, a predetermined amount of selectively doped silica is deposited and consolidated on the inner surface to form an intermediate uncollapsed preform tube. At least a portion of the intermediate uncollapsed preform tube is removed from the chemical vapor deposition apparatus, installed in a collapsing apparatus and collapsed. The collapsing uses an oxy-hydrogen burner or a plasma torch. Optionally, additional deposition is performed during the collapsing operation. A stretching may be performed concurrent with the collapsing.

### BACKGROUND OF THE INVENTION

1. Field of the Invention

The present invention is directed to optical fiber and, more particularly, to a modified chemical vapor deposition (MCVD) and plasma chemical vapor deposition (plasma CVP) method and apparatus for producing an optical fiber preform and an optical fiber from same.

2. Related Art

Modified chemical vapor deposition (MCVD) and plasma CVD are known methods for making optical fiber preforms.

MCVD processing of a preform is typically performed on a single lathe having an oxy-hydrogen burner and a precision controlled chemical gas delivery system for injecting chemicals into the hollow of the tube. More particularly, MCVD processing typically mounts a silica target tube within rotatable chucks of a deposition lathe. While the tube is rotating, gas phase chemicals, collectively referenced herein as CFIT, are injected by a precision controlled chemical gas source system into the tube's center, or hollow, as the burner traverses lengthwise down the tube. The heat from the burner induces chemical reactions on the inside of the tube, depositing soot and consolidating it to form glass layers according to the composition of the CFIT. Traversing the oxy-hydrogen burner along the tube and injecting the CFIT is repeated in a cyclical fashion until a desired thickness of glass is deposited on the inner surface of the tube. During the cycling the CFIT injection must be precisely controlled to obtain the particular optical qualities specified for the fiber that will be made from the preform. For example, fiber optic cable typically has a tightly specified index-of-refraction profile. The profile is obtained by precisely varying the CFIT chemicals as the burner cycles back and forth traversing along the tube. The precision of the CFIT chemical delivery is therefore a substantial factor determinative of the quality of the preform.

After the desired thickness of glass is deposited the chemical flow through the tube center is stopped. The burner intensity is then increased, and the tube is collapsed into a preform. The preform is cooled, moved to a drawing apparatus, heated and stretched to form the fiber.

Plasma CVD is similar to MCVD except that a plasma torch is traversed along the silica target tube as the CFIT chemicals are injected into the hollow by the chemical delivery system. Typically plasma CVD processes use a glassworking lathe similar to that used by MCVD processing.

Improvements to MCVD and plasma CVD have been made, many being directed to increasing the deposition rate and/or to improving the quality of the deposited silica. The need for such improvements has increased due to continuing increases in demand, for quantity as well as performance, in fiber optic cable. The general industry approach for adding production capacity is to purchase and install additional MCVD or plasma CVD deposition lathe systems. The capital required for such addition is typically high. The cost is compounded when the additional machinery includes a change or improvement that is not fully tested when installed.

Notwithstanding the increased requirements for quantity, quality and cost, a remaining shortcoming in the present MCVD and plasma CVD methods is that the same lathe is used for both the chemical vapor deposition/consolidation deposition and the collapsing. The result is inefficient allocation of manufacturing resources. A significant reason that this is inefficient resource allocation is that the MCVD or plasma CVD lathe includes a costly chemical delivery system for the CFIT chemicals. The chemical delivery system is costly because, as identified above, the dopant chemicals within the CFIT must be precisely delivered during the deposition step to obtain the desired optical qualities for the fiber. Furthermore, the deposition temperature must be well controlled. Otherwise, the chemical reaction of the dopants would not take place properly and/or the consolidation of the soot particles will be improper. Collapsing, however, does not require precise delivery of dopant chemicals. Collapsing also does not require the temperature to be controlled as tightly as does MCVD or plasma CVD. In other words, a slight variation of the temperature during the collapsing operation would not affect the quality of the preform. Therefore, the prior art's use of the same lathe for the chemical vapor deposition and the collapsing results in the costly chemical delivery system, and the torch system designed for tight temperature control, being unavailable as an MVCD or plasma CVD resource for the duration of the preform collapsing step.

The time duration that the MCVD or plasma CVD deposition resource is used for collapsing, and therefore unavailable for its deposition function is significant. For example, in a typical MCVD processing of a preform for making single mode fiber, the MCVD operations of set-up, fire-polishing, and deposition require approximately ten hours. The collapsing step requires approximately the same amount of time, which is ten hours.

Therefore, in the existing art of MCVD processing the MCVD lathe system is only being utilized 50 percent for actual MCVD. Comparable inefficiency exists in the existing art of plasma CVD processing.

Another inefficiency is that the flame control during the collapsing step does not have to be as good as the control during the deposition step. In further detail, there are two modes to control the heat, or temperature, during the fabrication process. One can be termed “temperature control mode,” and typically employs a temperature sensor or pyrometer to measure the temperature, and feed the measurement to a controller, which compares it to a set temperature through a PID or fuzzy logic control. Based on the comparison the controller sets the flow rate of hydrogen and oxygen to the torch, maintaining the temperature at a constant level within one or two degrees Celsius. This mode is typically used for deposition and consolidation. Collapsing, though, does not require such tight temperature control. The temperature variation can be ten degrees or more.

Further, during deposition the torch flame intensity cannot be so high as to cause premature collapsing of the tube. Collapsing, on the other hand, especially the rate of collapsing, typically benefits from a higher flame pressure. Flame intensity of this kind, though, is at least partially constrained by the torch design. In other words, a torch having a design optimized for deposition and consolidation will not perform collapsing as well as a torch optimized for collapsing, or visa versa.

There are disclosures in the prior that include collapsing and deposition being performed on separate equipment. Each has shortcomings.

Townsend et al, Electronics Letters, Vol. 23-7, 1987, pp. 329-331 (“Townsend”), and U.S. Pat. No. 6,192,713 to Zhang et al. (Zhang”), describe similar variations of MCVD in which soot is deposited on a starting tube, but not consolidated, to form an intermediate core member. The deposition without consolidation is performed on a deposition lathe. The intermediate core member is then removed from the deposition lathe and doped by soaking it in a solution. The member is then dried, sintered, and collapsed to form a preform.

One shortcoming in Townsend's and Zhang's described methods is that the doping requires a separate soaking step and a special drying step. Likewise, the consolidation of the soot is yet another step. The deposition tube needs to be removed from the lathe for these steps. Further, the dopants in Townsend's and Zhang's described methods do not have sufficient vapor pressure to be used as dopants are used in a typical MCVD process. In Townsend's described method, the core is doped with liquid, which is not done in typical MCVD processing. In Zhang's described method, both liquid and vapor dopants are used. Further, the vapor phase is described as generated by heating the solids directly.

Philips Corporation publications (“Production of Optical Fibres Based on the PCVD Process”) describe a Plasma Chemical Vapor Deposition (PCVD) process in which, using a first lathe-type apparatus, glass layers are built up on the inside of a silica tube using a non-isothermal plasma. The apparatus includes a microwave resonator which surrounds and moves alongside the tube, enclosed in an oven heated to approximately 1200° C. Once the desired core diameter is achieved the silica tube is moved to another lathe where it is collapsed by traversing an oxygen-hydrogen torch. The described Philips plasma apparatus, unlike an MCVD lathe and its supporting apparatus, is not capable of collapsing the preform. The Philips described process uses PCDV, not MCVD to deposit the glass. One effect is that the glass layers deposited by PCVD are not the same as glass layers deposited by MCVD. An example, the glass layers deposited by the PCVD process are approximately one micron thick. Glass layers deposited by MCVD are significantly thicker.

Still another inefficiency in prior art MCVD and plasma CVD methods is that the step of stretching the preform into a fiber is typically carried out on a separate machine, as a step separate from the collapsing step.

### SUMMARY OF THE INVENTION

The present invention advances the art, and overcomes the aforementioned shortcomings in making an optical fiber preform by MCVD, by a first aspect which performs the MCVD deposition on an MCVD lathe system, removes the tube from the MCVD lathe, and collapses it into a preform tube in a collapsing lathe.

The present invention still further advances the art by an aspect which performs the stretching operation on the same lathe as used for the collapsing.

An example apparatus includes an MCVD apparatus having, for example, a glassworking lathe, having chucks for securing and rotating a hollow tubular silica member about a center axis, and a movable support for a plasma torch. A oxy-hydrogen burner is secured to the movable support for generating a hot zone incident on an outer surface of the hollow tubular silica member. A first translation actuator moves the movable support at a selectable translation rate parallel to the center axis. A second translation actuator moves the movable support toward and away from the center axis to space the plasma flame or burner hot zone selectively with respect to an outer surface of the tubular member. A chemical source selectively injects CFIT chemicals into one end of the rotating tubular member while the oxy-hydrogen burner or plasma flame is traversed in the axial direction.

The example apparatus further includes a collapsing apparatus, an example comprising a glassworking lathe having chucks for securing and rotating a tubular member after it has been processed on the first workpiece rotation and heating apparatus. A first embodiment includes an oxy-hydrogen burner mounted on a support movable parallel to the axis of rotation. A second embodiment substitutes a plasma torch for the oxy-hydrogen burner. The collapsing apparatus does not require the precision CFIT chemical delivery system of the chemical vapor deposition apparatus and advanced temperature controller.

One variation of the collapsing apparatus includes a second chemical delivery system associated with the second workpiece rotation and heating apparatus, for depositing and consolidating substantially pure silica on the outer surface of the preform.

A first method includes providing a tubular starting member having a cylindrical outer surface, a cylindrical bore having a longitudinal axis, a first end, a deposition length extending in the direction of said longitudinal axis, and a second end opposite the first end. The tubular starting member is installed in the chemical vapor deposition apparatus. Next, a sintered silica is deposited and consolidated on the cylindrical bore along the deposition length until a predetermined thickness of silica is deposited and consolidated, thereby forming an intermediate tubular preform member, a section of which is an uncollapsed preform tube.

The uncollapsed preform tube is then installed in the collapsing apparatus and collapsed into a preform by rotating it while traversing a heat source in the axial direction.

Optionally, a length of the intermediate tubular preform member having the uncollapsed preform tube is separated from the remainder of the intermediate tubular preform member prior to being installed in the collapsing apparatus.

The separation of the length of the intermediate tubular preform member may be performed by necking down a first linear region of the intermediate tubular preform member to form a closure within the cylindrical bore at a location distal from the first end. A first side of the closure faces the cylindrical bore and a second side opposite the first side faces away from the cylindrical bore. A material extending out from the second side and connecting to the remainder of the intermediate tubular member is cut, thereby separating the length having the uncollapsed preform tube from the remainder.

A further embodiment includes measuring optical qualities of the uncollapsed preform tube prior to collapsing it into a preform.

A still further embodiment includes depositing additional silica on the outer surface of the uncollapsed preform tube.

A further embodiment includes stretching the preform during at least a portion of the collapsing.

One objective of the invention is lowered cost and improved production rate compared to MCVD and PCVD methods of the existing art.

Another objective is to provide for testing and qualifying the optical characteristics of the preform prior to collapsing the preform, thereby saving the significant time and expense of carrying out a collapsing operation on a defective preform.

A still further objective is to reduce the core ovality, thereby reducing polarization mode dispersion.

These and other objects, features and advantages will become more apparent to, and better understood by, those skilled in the relevant art from the following more detailed description of the preferred embodiments of the invention taken with reference to the accompanying drawings, in which like features are identified by like reference numerals.

### BRIEF DESCRIPTION OF THE DRAWINGS

FIG. 1 is a cross-sectional view of an example starting tube assembly for carrying out a method according to the present invention;

FIG. 2 shows the starting tube assembly of FIG. 1 mounted in an example deposition/consolidation apparatus for performing the step of forming an uncollapsed preform according to the present invention;

FIG. 3 shows an example neck-down operation within the step of forming an uncollapsed preform;

FIG. 4 shows a completion of the neck-down operation depicted by FIG. 3;

FIG. 5 shows an example mounting of the uncollapsed preform in a collapsing apparatus for forming a collapsed preform according to the method of the present invention;

FIG. 6 is an example flow chart showing a two-stage preform processing, using a deposition lathe such as shown in FIG. 2, followed by a collapsing lathe such as shown in FIG. 5;

FIG. 7 is an example flow chart of a method according to FIG. 6, modified for concurrent stretching/consolidation, and

FIG. 8 is an attenuation with respect to wavelength characteristic of a fiber drawn from a preform made in accordance with the present invention.

### DETAILED DESCRIPTION OF THE INVENTION

1. Overview

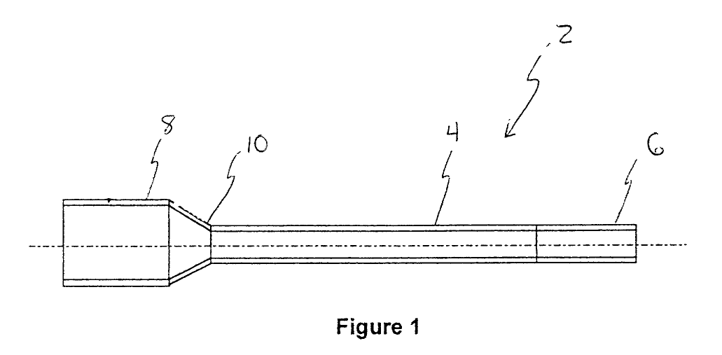

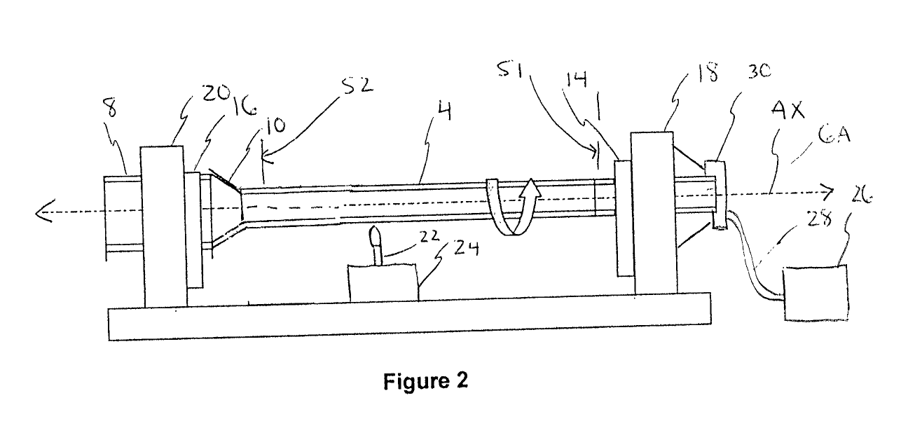

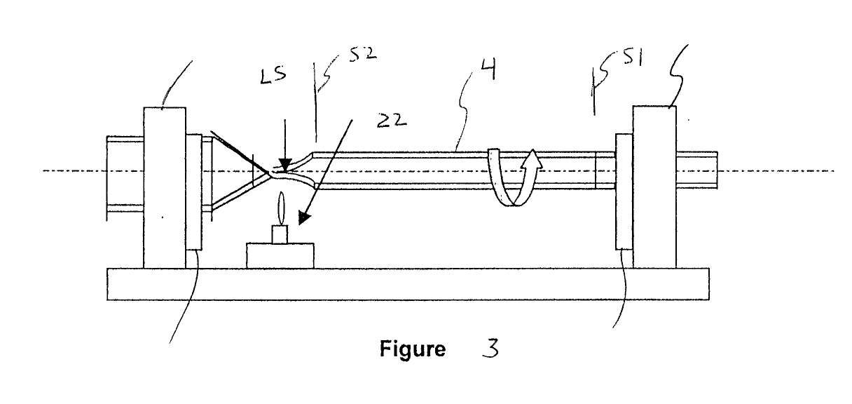

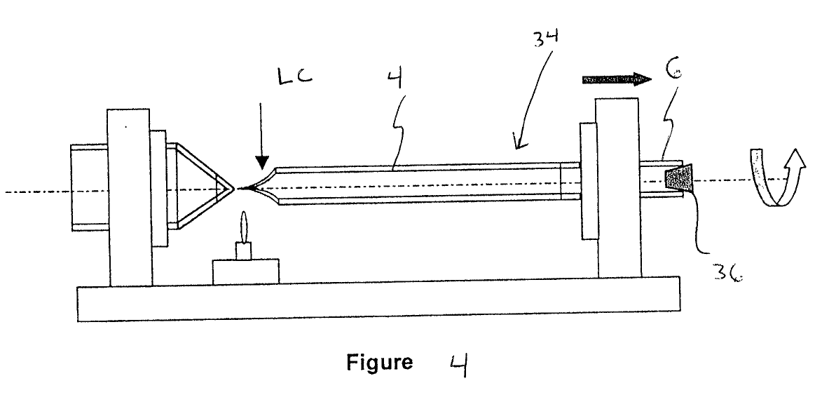

This is a two stage method for forming a preform. The first stage installs a starting tubular member into a MCVD apparatus and deposits and consolidates a user-specified thickness of silica along the member's inner surface. An example starting tubular member 2 is shown by FIG. 1, and an example mounting of the starting tubular member in an MCVD deposition/consolidation apparatus is shown by FIG. 2. The deposition and consolidation results in an intermediate tubular member, with a length of the intermediate tubular member being an uncollapsed preform tube. An optional separation operation is performed to separate the length having the uncollapsed preform tube from the remainder of the intermediate tubular member. FIGS. 3 and 4 depict an example separation carried out by a neckdown operation.

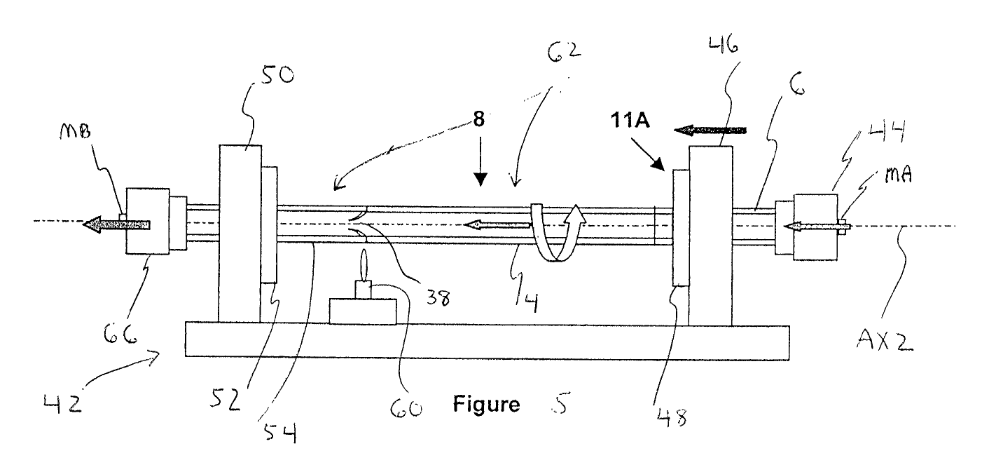

Stage two installs at least a section of the intermediate tubular member having the uncollapsed preform tube into a collapsing apparatus, which is separate from the chemical vapor deposition apparatus on which stage one was carried out, and collapses it into a preform. FIG. 5 shows an example installation of the uncollapsed preform tube in a collapsing apparatus.

2. Detailed Description

FIG. 1 shows a cross-sectional of an example starting tube assembly 2 prior to undergoing chemical vapor deposition.

Referring to FIG. 1, the example starting tube assembly 2 consists of a deposition tube 4 secured and sealed at one end to an inlet tube section 6 and secured and sealed at the other end to an exhaust tube section 8 by way of a transition region 10. As shown, the example transition region 10 preferably comprises a flare of, for example, about 45 degrees, extending over, for example, a few centimeters. The flair of the transition region 10 provides a smooth transition between the deposition tube section 4 and exhaust tube section 8. The flair also prevents soot particles from walking back from the exhaust tube 8 into the deposition tube 4.

FIG. 2 shows an example apparatus and set-up for performing MCVD on the starting tube assembly 2. The example apparatus includes a conventional glass-working lathe 12 having a pair of rotating chucks 14 and 16, supported within a headstock 18 and a tailstock 20, respectively. An oxy-hydrogen burner 22 is supported on a carriage 24, the carriage riding on rails or ways and moved thereon, in the AX direction, by a conventional lathe carriage translation mechanism.

The terms “upstream” and “downstream” are used to reference positions along the tubular member 2 relative to the direction of the CFIT flow through the tube. For example, since the CFIT flows from the inlet opening 6A through to the exit 8A of the exhaust tube section 8, the opening 6A is upstream of the opening 8A.

Referring to FIG. 2, a chemical delivery system 26 has a delivery tube 28 connected to the opening 6A of the inlet tube 6 via a first rotating seal 30. The chemical delivery system 26 delivers precision controlled mixtures of CFIT chemicals in accordance with the known art of MCVD. The exhaust tube 8 section of the tube 2 serves as an outlet conduit for the gasses and as a collector for undeposited glass soot. Depending on environmental requirements, the exhaust tube 8 may be connected to a chemical scrubbing system (not shown), as is known in the art of MCVD.

An example operation of the deposition/consolidation stage is started by installing the starting tube assembly 2 in the chucks 14 and 16, aligning it such that the central axis of the tube 2 is collinear with the axis of rotation AX. The alignment may be in accordance with methods and techniques known to persons having ordinary skill in the MCVD arts. After the alignment step, the burner 22 is warmed up and fire polishing steps are carried out.

Next, soot is deposited and consolidated on the inside of the tube using torch intensity, lathe rotational speed and torch traversal rates known in the art, until the desired thickness of glass is deposited. As known in the pertinent art, during the deposition CFIT dopants are introduced by the chemical delivery system 26 through the delivery tube 28 to achieve the desired optical property profile.

After the deposition and consolidation is complete the portion of the assembly 2 extending between the lines labeled S1 and S2 is usable for collapsing into a preform. The portion extending between the S2 and the flared transitional region 10 is typically not usable because of optical qualities arising from a phenomenon referenced generally in the art of MCVD as “downstream taper.”

In a preferred embodiment a linear section of the tube assembly containing the usable portion from S1 to S2 is next separated from the remainder of the tube 2 to be mounted on, and collapsing by, an apparatus separate from that on which the deposition and consolidation was performed. The separation is not, however, a required operation because the entire tube assembly 2 can be mounted in the collapsing apparatus for collapsing the usable portion between S1 and S2.

An example separation operation is a necking down and closure that will be described in reference to FIGS. 3 and 4. Referring to FIG. 3, the tube 2 is necked down at the linear section LS to a tapered end and closed off to a closure LC, at a position proximal the exhaust tube section 8. An example length (not labeled) of the tapered portion is about two centimeters. The necking down to a taper and closure LC is preferably carried out with the burner 24 adjusted to have higher heat output. As identified above, the loss of the linear section LS causes no substantial loss of usable core glass because this area is normally not usable because of a so-called “downstream taper” phenomenon.

Preferably, during the necking down operation the pressure inside the tube 2 relative to the outside of the tube is controlled such that at the beginning of the process there is a slight overpressure, with the overpressure being gradually reduced to zero as the process is completed. Equation (1) described below is an example formula for maintaining the overpressure. The numeric value of the pressure differential is selected based on the inner and outer diameters of the deposition tube 4, and on the thickness and composition of the silica layer deposited on its inner surface by the chemical vapor deposition operation. The overpressure prevents unconsolidated soot particles in and proximal to the closure LC from walking up stream toward the inlet end 6A and damaging the good section of the deposition tube 4 between S1 and S2. The pressure must be reduced to zero as the region LS is closed off to form LC to prevent the tube from rupturing. An example apparatus for reducing the pressure to zero is a bypass pressure chamber (not shown) connected in line with the delivery tube 28 connected to the inlet end 6A.

After the neckdown and closure is complete, the tube assembly 2 is allowed to cool down and the portion of the tube assembly 2 to the right, or upstream of the LC end is separated from the portion of the tube assembly 2 to the left, or downstream of the LC end, which is secured within the chuck 14. The separated portion is referenced hereafter as the closed preform tube assembly 34. The portion remaining in the chuck 14 can then be discarded and another starting tube assembly 2 mounted in the chucks 14 and 16 to begin another deposition process. The closed end created by the neckdown operation is labeled as item 34C The above-described MCVD step forms a closed preform 34 which, after being opened up to form the uncollapsed preform tube 38 that allows monitoring of the pressure during the collapsing step at both point MA and point MB labeled in FIG. 5. Point MA is upstream and point MB is downstream with respect to the pressurizing gas flowing during the collapsing step. This upstream/downstream pressure measurement feature is not feasible with the existing MCVD methods. The reason is that existing MCVD methods produce excess soot particles downstream of the hot zone, and these particles become trapped along a length proximal to the downstream end of the tube (which is also referred to as the “exhaust tube.”) As described above in reference to FIGS. 3 and 4, however, the present invention discards the “exhaust tube” length 8 and transition length 10 after the necking down and separation operations.

Referring to FIG. 4, a plug 36 of, for example, silicon rubber is preferably inserted into the 6A end to prevent contaminants from entering the closed preform tube assembly 34. An example cool-down time before removing the tube is approximately 15 minutes, at which time an example temperature is about 40 degrees Celsius.

A hole 38 is then created in the closed end LC, thereby creating an uncollapsed preform assembly 40 which is mounted in a collapsing lathe apparatus, for subsequent collapsing as, for example, shown in FIG. 5 described below.

FIG. 5 shows an example mounting of the uncollapsed preform assembly 40 within a collapsing lathe 42. The collapsing lathe 42 may have a structure identical to the MCVD lathe shown in FIG. 2, but does not require the chemical/dopant precision controlled gas delivery system 26 required for MCVD, as described above.

An example operation for forming the hole 38 to make the uncollapsed preform assembly 40 from the closed preform assembly 34 is as follows: First the plug 36 shown in FIG. 4 is removed and, referring to FIG. 5, a first rotary seal 44 is attached. Rotary seals are known in the art, and therefore further description is omitted. Next, a gas, preferably chlorine, is introduced through a regulated source (not shown) to slightly pressurize the closed preform tube assembly 34 to a pressure of, for example, approximately ten to fifty Pascals. The operator then heats the closed end 34C with, for example, a hand-held torch to form the hole 38, having a diameter of, for example, about 5 mm.

The pressurization gas is preferably chlorine to minimize the moisture content of the preform. Moisture in the preform introduces absorption losses within the resulting fiber at specific wavelengths. A primary mechanism by which moisture causes absorption losses is that moisture, as hydroxyl (OH) ions dissolved in the preform, introduces fundamental stretching vibrations occurring at a wavelength of 2.73 micrometers. The fundamental vibrations of OH give rise to overtones at wavelengths of 1.38 and 0.95 micrometers. These vibrations typically cause additional absorption loss at the respective wavelengths. When these overtones combine with the fundamental SiO₂ vibrations more absorption loss appears at wavelengths of 1.24, 1.13 and 0.88 micrometers. These absorption losses affect the performance of the fiber.

Moisture can be more of a problem during the collapsing that during the chemical vapor deposition, even though a significant of amount of moisture is generated during the deposition operation. A reason is that most of this moisture generated during deposition is scavenged out by chlorine constituents of the CFIT gases. More particularly, during chemical vapor deposition significant moisture arises from hydrogen-containing species of the raw materials interacting with one another during the chemical vapor deposition. The raw materials include gases and chlorides. During the chemical vapor deposition, though, there is a chlorine rich atmosphere due to the chemical reactions of SiCl₄ and GeCl₄ with oxygen, resulting in SiO₂, GeO₂ and chlorine (Cl₂). This chlorine acts as a hydrogen scavenger, by converting the hydrogen to HCl, which is carried out into the scrubber system.

During the above-described heating process creating the hole 36 and the collapsing operation described below, however, there are no significant chlorine-producing reactions occurring inside the closed tube assembly 34 or the open tube assembly 40. Therefore, hydrogen scavenging chemicals are not automatically produced as they are during the chemical vapor deposition. To scavenge the hydrogen, and thereby prevent unacceptable generation of moisture, chorine gas is injected into the closed tube 34 and caused to flow through the tube 38 during the collapsing operation. The flow begins with pressurizing the closed-off uncollapsed preform tube 34 prior to creating the hole 36, and afterward maintaining the chlorine flow through the uncollapsed preform assembly 40 for as long as possible during the collapsing operation, as described below.

After the hole 36 is created the gas, preferably chlorine, that had been pressurizing the interior of the closed preform assembly 34 will flow. A further benefit obtained by pressurizing the closed tube 34 as the end LC is heated to open the hole 36 is that soot resulting from the hand-heating operation is prevented from migrating toward the end 6A and contaminating the interior of the tube.

Referring to FIG. 5, the example collapsing lathe 42 includes a headstock 46 supporting a headstock chuck 48, and a tailstock 50 supporting a tailstock chuck 52. For the depicted example lathe 42, which is a horizontal lathe, one of both of the headstock 46 and tailstock 50 are movable along, and clampable to, lathe ways (not shown). Such mechanisms are well known in the relevant art and therefore do not require further description. With continuing reference prior to mounting the uncollapsed preform assembly 38 to FIG. 5, the handle tube 54 is clamped within the tailstock chuck 52. The clamping is performed such that the longitudinal axis (not labeled) of the handle tube 54 is collinear with the rotational axis AX2 of the lathe.

After the hole 36 is formed and the handle tube 54 is secured with the tailstock chuck 52, the uncollapsed preform to assembly 38 is aligned on the AX2 axis and the headstock 46 and tailstock 50 are urged toward one another to compress the inward and 54A of the handle tube 54 against the distal end 38D of the uncollapsed preform assembly 38, with the section 6 extending through and clamped by the headstock chuck 48. The urging force is, for this example, maintained by clamping one or both of the tailstock chuck 52 and headstock chuck 48 along ways (not shown) of the lathe.

It is preferable that the diameter (not separately labeled) of the uncollapsed preform assembly 38 and the diameter (not separately labeled) of the handle tube 54 are matched within approximately 1 mm of each other. The tolerance of approximately 1 mm was based on numerous test runs. Different set-ups, equipment, and different quality standards may benefit from tolerance ranges different from 1 mm, but which can be readily identified from test runs.

The FIG. 5 example collapsing lathe 42 further includes a carriage 58 supporting an oxy-hydrogen burner 60. The carriage is movable in the AX2 direction. The burner 60 is supported to be movable toward and away from the outside surface of the uncollapsed preform assembly 38, in for example, the manner known in the prior art collapsing operation. After the uncollapsed preform 38 is secured at one end by the headstock chuck 48 and at the other end by compression against the handle tube 54, the lathe chucks 48 and 52 are rotated and the burner 60 is started. The burner is then positioned as shown in FIG. 5 to heat the region proximal to the mating 55 between the handle tube 54 and the uncollapsed preform tube 38 sufficiently to fuse the tube 38 to the handle tube 54. The fusion preferably forms a gas tight joint. A temporary unitary structure, labeled generally as 62, is formed by the handle tube 54 fused to the uncollapsed preform tube 38.

Although not a strict requirement, it is preferable after fusing the uncollapsed preform tube 38 to the handle tube 54 to realign the temporary unitary structure 62 within the lathe chucks 48 and 52, so that the longitudinal axis (not labeled) of the structure 62 is aligned with the axis of rotation AX2 of the lathe. General techniques for alignment within a lathe chuck can be applied to this particular alignment by persons having ordinary skill in the arts to which this invention pertains, upon reading the present disclosure.

After the above-described fusing operation and, if desired or necessary, the step of realigning the temporary unitary structure 62 with the rotational axis AX2 of the lathe, a second rotary seal 66 is preferably connected to the outermost distal end of the handling tube 54. The second rotary seal 66 is not strictly required, but is preferable to facilitate guiding the outlet gas flow from the following described collapsing step into a scrubber system (not shown). The objective of the above-described example of opening the closed preform tube assembly 34 into an uncollapsed preform tube 38 is to protect against contaminants entering or adhering to the interior of the tube. It will be understood that the described steps are only examples and, in some aspects, are particular to the FIG. 5 mounting example. Other steps and techniques for protecting against contaminants entering or adhering to the interior of the tube 34, or 38, during transport from the FIG. 2 chemical vapor deposition apparatus to a collapsing apparatus as shown in FIG. 5 will be identified by persons skill in the art upon reading this disclosure.

The collapsing step preferably starts with a warm-up step, gradually bringing the section 4 to a temperature of approximately 1600° Celsius. Preferably a gas stream having, for example, approximately 20% chlorine gas is flowed through the temporary unitary member 62, from a source (not shown), in through the first rotary seal 44, through the hollow of the tube, and out through the second rotary seal 66, as shown by arrow FL. The chlorine gas concentration is preferably similar to the chorine gas concentration used during the chemical vapor deposition operation.

The burner 60 is then traversed back and forth to collapse the section 4 of the tube 62. As the tube collapses the chlorine gas flow is preferably regulated, either continuously or in a step manner after each pass of the torch, to maintain the pressure difference between inside and outside according to the following formula:

Pressure=850×(1/Do+1/D), (1)

where

Do=outside tube diameter (millimeters),

Di=inside tube diameter (millimeters),

P=equilibrium pressure (in Pascals)

A general guideline for controlling the pressure is that it should be maintained within approximately 50% to 80% of the Equation (1) calculated value. Maintaining the pressure difference within this approximate range throughout the collapsing process helps prevent unacceptable deformation of the uncollapsed preform. Such deformation must be minimized, or maintained within tolerances readily calculable by persons skilled in the art to which this invention pertains based on the performance requirements of the finished fiber. The reason is that, as known to such persons, the circularity of the preform directly transfers to circularity of the preform core (not shown).

Preferably, the pressure is monitored at both the MA and MB point labeled on FIG. 5, where MA is upstream and MB is downstream. The upstream/downstream pressure measurement enables better control of the pressure than possible with the prior art. The better pressure control enables better fiber geometry. The present inventors have identified that pressure control is particularly important at the final stage of the collapsing close-off when the tube opening (not shown) is extremely small but not yet closed off. If the pressure is too low, and the capillary opening is intermittently closed off or interrupted during the final collapsing phase, bubbles may be formed by packets of gas being trapped. On the other hand, if the pressure is overly high, there is a likelihood of the opening in the collapsing tube being too large. This condition has a likelihood of causing undesirable ovality in the finished preform. Uncontrolled ovality is undesirable, especially if fibers having a low polarization mode dispersion are required.

Preferably the heat of the collapsing burner 60, the heat profile incident on the usable portion of the temporary unitary member 62 being collapsed, namely the deposition section 4, and the rotation speed of the lathe 42 during the collapsing step are selected to collapse the tube as quickly as possible. Quick collapsing is desirable because, typically, the shorter the collapsing time the shorter the time available for un-reacted hydrogen molecules to diffuse into the deposited glass. Minimizing the time available for diffusion therefore tends to minimize OH content in the preform. It is preferable for this reason to select a collapsing burner 60 that provides a much narrower heat zone than typically used for MCVD operations. An example implementation, for smaller preforms, is a type “141/18/70”, available from Herbert Arnolg GmbH & Co. KG, having a location in Weilburg, Germany, or an equivalent.

To further provide a narrower heat zone it is also preferable to include an additional mechanical stabilizer. The mechanical stabilizer preferably comprises two pneumatically controlled graphite rods, positioned on either side of the torch. Positioned and configured as such, the stabilizer balances the weight of the uncollapsed preform. This helps balance the drooping of the preform, thereby preventing it from becoming bowed, snake shaped, or incurring other undesired physical distortions.

For larger preforms, an example collapsing torch is a type 141/18/8011, available from the same commercial source, or an equivalent.

The term “smaller preform” is used herein to reference a preform having a diameter less than approximately 40 mm, or from which less than 100 kilometers of fiber can be drawn from each one meter length. The term “larger preform” refers to a preform having a diameter larger than approximately 70 mm, or from which approximately 300 or more kilometers of optical fiber can be drawn for each meter in length.

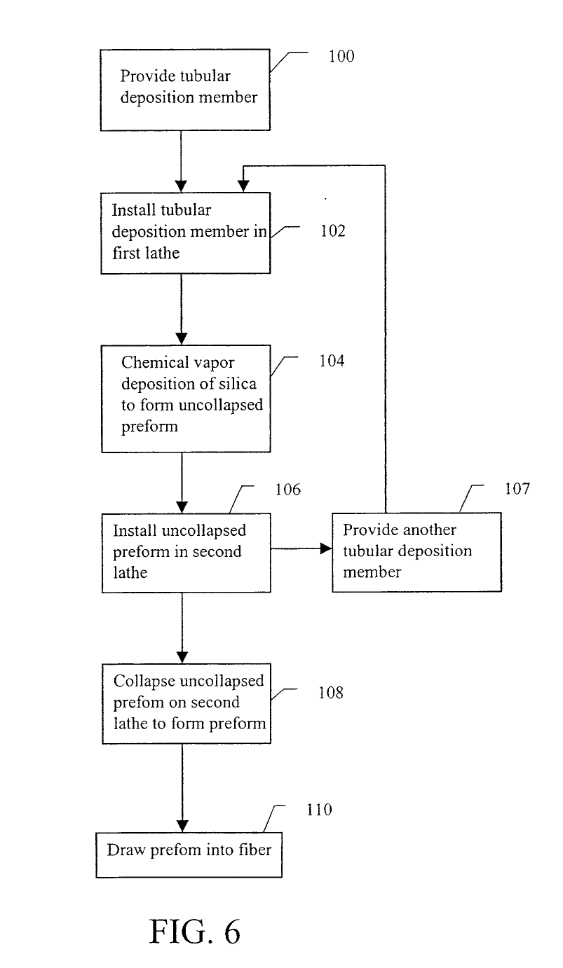

FIG. 6 is an example block flowchart showing a preform processing according to the methods described. The FIG. 6 example depiction of an example process starts at step 100, which is providing a tubular member having a cylindrical outer surface, a cylindrical bore having a longitudinal axis, a first end, a second end opposite said first end, and a deposition section extending in the direction of said longitudinal axis. An example step 100 tubular member is the FIG. 1 starting tube assembly 2 formed of a deposition tube 4 secured and sealed at one end to an inlet tube section 6 and secured and sealed at the other end to an exhaust tube section 8 by way of a transition region 10. Next, at step 102, the tubular member is installed in a first lathe having an oxy-hydrogen burner, such as the conventional glass-working lathe 12 described above, having rotating chucks 14 and 16, respectively, and supporting the oxy-hydrogen burner 22 supported on the carriage 24. An example of this installation is described above in reference to FIG. 2 as the installation of the starting tube assembly 2 in the chucks 14 and 16, aligning it such that the central axis of the tube 2 is collinear with the axis of rotation AX.

After the installation, the process goes to step 104, which is a chemical vapor deposition of a sintered silica on the cylindrical bore along the deposition section until a predetermined thickness of silica is deposited. An example of step 104 is described above as warming the burner 22, followed by fire polishing, and then depositing and consolidating soot on the inside of the tube using torch intensity, lathe rotational speed and torch traversal rates known in the art, until the desired thickness of glass is deposited. Typically, during the deposition CFIT dopants are introduced by, for example, the chemical delivery system 26 through the delivery tube 28 to achieve the desired optical property profile, as described.

With continuing reference to FIG. 6, after the predetermined thickness of silica having the desired optical profile is formed, the process goes to step 106 wherein the deposition section is rotated on a second lathe. An example of this rotation on a second lathe is described above in reference to FIGS. 3 and 4 as separating the deposition section from the remainder of the tube in the first lathe by, for example, the described necking down and closure operation, followed by inserting the plug 36 into the open end, and then fusing the uncollapsed preform assembly 38 to a handle tube 54 mounted in the tailstock chuck 52 of the collapsing lathe 42 to form a temporary unitary member 62, as described above in reference to FIG. 5.

Next, the process goes to step 108 and collapses the rotating deposition section by heating with a torch to form a preform. An example of the step 108 collapsing is described above in reference to FIG. 5, as starting with a warm-up step gradually bringing the section 4 to a temperature of approximately 1600° Celsius, and then traversing the burner 60 back and forth to collapse the section 4 of the tube 62. The step 108 collapsing is preferably carried out, as described above, by flowing a gas stream having, for example, approximately 20% chlorine gas through the temporary unitary member 62. As also described, as the tube collapses the chlorine gas flow is preferably regulated, either continuously or in a step manner after each pass of the torch, to maintain the pressure difference between inside and outside according to formula (1).

Referring to FIG. 6, upon completion of the step 108 collapsing a preform is obtained. The process then goes to step 110 to draw the finished fiber product from the preform in accordance with methods known in the art.

With continuing reference to FIG. 6, a further feature is to install another tubular member in the first lathe after with removing the previously deposited, but uncollapsed preform from the first lathe and installing it in the second lathe for collapsing. The installation is show as step 107, which is identical to the step 100 installation. The first lathe then performs steps 102 through 104 on the installed another tubular member concurrent, at least in part, with the second lathe carrying out steps 106 and 108 on the previously deposited, but uncollapsed preform removed from the first lathe.

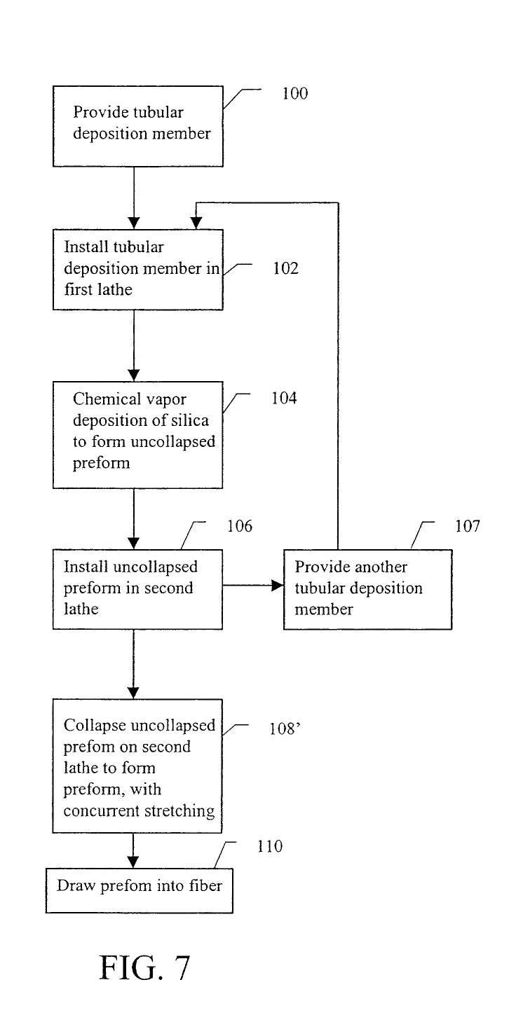

FIG. 7 is an example block flow chart describing a further method according to the invention. The FIG. 7 method forms an uncollapsed preform on a first lathe, and then installs and rotates the uncollapsed preform on a second lathe, as described above in reference to FIG. 6. Therefore, the FIG. 7 blocks 100 through 106 have identical reference numbers to those of FIG. 6. The method of FIG. 7 differs in that collapsing and stretching operations are carried out, at least in part, concurrently by step 108′.

Referring to FIG. 5, the only modification to the depicted apparatus required for performing the concurrent collapsing/stretching operation of FIG. 7 step 108′ is that the tailstock 50 must driven by a motor (not shown) along the ways (not shown) of the lathe 42. Mechanisms for driving the tailstock of a lathe are well known to persons of ordinary skill in the relevant arts and, upon reading this description, such mechanisms are readily selected and adapted to these described methods by such persons. To perform the stretching while collapsing, the headstock 46 must be kept stationary as the torch 60 is traversed, while the tailstock 52 is progressively moved away from the headstock. The step 108′ collapsing/stretching may be performed either during a collapsing pass of moving the torch 60 forward (same direction as gas flow) or in reverse (opposite direction of the gas flow) directions.

The rate of moving the tailstock 50 away from the headstock 46, i.e., the stretching, is preferably based on the direction of the torch 60 and the desired rate of reduction, and the relationship can be described for stretching while the torch 60 is moving in the forward direction by the following equations (2) and (3), and for stretching while the torch moves in the reverse direction by equations (4) and (5).

$$\begin{matrix}( {OD}_{i}^{2} - {ID}_{i}^{2} ) \times {S}_{b} = ( {OD}_{f}^{2} - {ID}_{f}^{2} ) \times ( {S}_{t} - {S}_{b} ) \\ or & ( 2 ) \\ {S}_{t} = [ ( \frac{{OD}_{i}^{2} - {ID}_{i}^{2}}{{OD}_{f}^{2} - {ID}_{f}^{2}} ) + 1 ] \times {S}_{b} & ( 3 ) \\ ( {OD}_{i}^{2} - {ID}_{i}^{2} ) \times {S}_{b} = ( {OD}_{f}^{2} - {ID}_{f}^{2} ) \times ( {S}_{t} + {S}_{b} ) & ( 4 ) \\ {S}_{t} = [ ( \frac{{OD}_{i}^{2} - {ID}_{i}^{2}}{{OD}_{f}^{2} - {ID}_{f}^{2}} ) - 1 ] \times {S}_{b} & ( 5 )\end{matrix}$$

where:

ODᵢ: Outside diameter (mm) before stretching and collapsing,

IDᵢ: Inside diameter (mm) before stretching and collapsing,

OD_{f}: Outside diameter (mm) after stretching and collapsing,

ID_{f}: Inside diameter (mm) after stretching and collapsing,

Sₜ: Speed (mm/min) of the tailstock, and

S_{b}: Speed (mm/min) of the torch.

One benefit of the concurrent collapsing/stretching step 108′ of FIG. 7 is reduced fuel consumption. Another benefit is a reduction of heat-induced glass evaporation from the collapsing preform surface. More particularly, during the FIG. 6 step 108 collapsing, and other preform collapsing processes, the wall thickness of the uncollapsed preform increases as its opening diameter reduces. When the uncollapsed preform wall thickness increases, more energy and hence more fuel, e.g., hydrogen and oxygen, is required to heat the tube. The additional heat causes more evaporation, i.e., loss of material, of the glass from the surface. Therefore, although the stretching operation within step 108′ can take place at any torch pass during the collapsing operation, it is preferable, to obtain the most benefit from the stretching lessening the wall-thickness, for the stretching to be conducted at a later stage of the collapsing.

Another benefit of the concurrent collapsing/stretching is that jacketing no longer requires a separate stretching operation. More particularly, it is general objective during the deposition/consolidation stage described above, and during the deposition/consolidation of prior art preform processing, to deposit as much glass as possible This minimizes the percentage of the time spent in set-up and clean-up. This is especially true for a single mode preform. However, a result of depositing such an amount of glass is that the primary preform may have too large of an outside diameter to fit into the jacketing tube. Stretching the preform is a solution for this, but it normally requires an additional step. The concurrent stretching/collapsing 108′ of FIG. 7 obtains the stretching solution to the jacketing problem without the burden of an additional step. This reduces set-up time and, therefore, reduces the end-to-end processing time.

A still further benefit of the concurrent stretching/collapsing of step 108′ is that it obviates the need for capital to add a stretching lathe. Such a capital expenditure would increase the processing rate, and the processing cost, in contrast to the processing rate/cost benefits obtained by depositing the glass on a first lathe and collapsing the preform on a second lathe, as described above. A major reason is that the FIG. 7 step 108′ stretching is concurrent with the collapsing. Therefore, performing the stretching on the same lathe as the collapsing does not make a resource that would otherwise be useful for collapsing unavailable.

The step 108′ concurrent stretching/collapsing may be used with single lathe MCVD and PVD processes of the prior art, as well in combination with the FIG. 6 two-stage process as depicted by FIG. 7. This process would, for example, comprise depositing and consolidating soot on an MCVD lathe as known in the prior art, with a motorized tailstock, followed by a collapsing using the same lathe, but with at least part of the collapsing being in accordance with the step 108/concurrent stretching/collapsing. Although not achieving the production benefits of the two-stage process, i.e. separate depositing and collapsing lathes, described herein in reference to FIGS. 1 through 6, the benefits of the concurrent stretching/collapsing would be attained.

Table I compares the average optical attenuation of preforms made according to the FIG. 6 method, with the average optical attenuation of preforms made according to the MCVD methods of the prior art. Referring to Table I, the row labeled “Off-Line” contains entries for the samples made by a method according to FIG. 6, and the row labeled “Standard” contains entries from the samples made by the prior art MCVD method. The number of samples for each row was six. The column labeled “AVG” contains the average measurement of the six samples, and the column labeled “STD” contains the sample standard deviation. The samples produced according to the prior art MCVD method were made on the same MCVD lathe system as used for the deposition phase of making the samples according to the FIG. 6 method. The only difference was that the prior art MCVD samples were collapsed on the same lathe, in accordance with known methods, while the samples according to the FIG. 6 method were collapsed on a collapsing lathe, with a burner hot zone optimized for collapsing as described above. Further, upstream/downstream pressure measurement was used during the collapsing operation for the samples made according to FIG. 6, as described above. As also described above, upstream/downstream pressure monitoring during the collapsing of preform tubes made according to the prior art is not possible. Otherwise, all of the process conditions between the samples according to FIG. 6 and the prior art MCVD samples were the same. Collapsing for all samples was performed using chlorine gas.

As can be seen from Table I, the optical performance of preforms made according to FIG. 6 is significantly better than that of preforms made according to comparable prior art methods. This benefit is additional to the efficiency improvement, namely the collapsing being performed on a separate, less expensive lathe, then the chemical vapor deposition.

TABLE I

| | | |
|---|---|---|
| OH Peak | 1310 nm | 1550 nm |
| (dB/km) | (dB/km) | (dB/kin) |

| Procedure | AVG | STD | AVG | STD | AVG | STD |
|---|---|---|---|---|---|---|
| Off-Line | 0.529 | 0.026 | 0.369 | 0.030 | 0.220 | 0.018 |
| Standard | 0.682 | 0.059 | 0.343 | 0.004 | 0.204 | 0.003 |

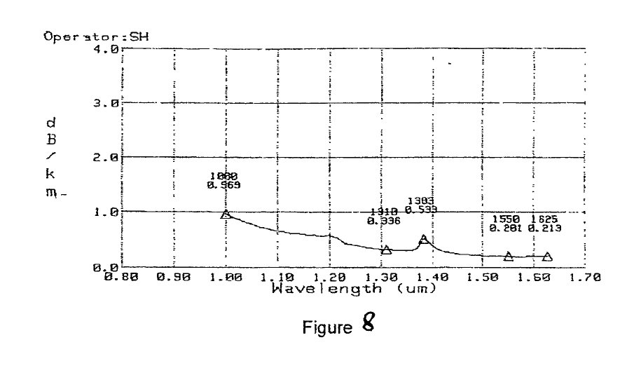

FIG. 8 shows a measured attenuation of a fiber produced from a preform made by a method according to FIG. 6. As seen from FIG. 8, the example fiber has low measured attenuation at the OH absorption peak wavelength, which is 1382 nm, regardless of the fact that a hydrogen/oxygen burner was used for the collapsing burner 60.

The above-described example methods of FIGS. 1-6 use an oxy-hydrogen collapsing burner 60 for the off-line collapsing step. A further embodiment substitutes a plasma torch for the oxy-hydrogen burner 60 to carry out the collapsing operation, and the concurrent collapsing/stretching step 108′ of FIG. 7. An example plasma torch is disclosed by U.S. Pat. No. 6,253,580 which is incorporated by reference herein as if set forth in its entirety. Due to the typical weight of a plasma torch being greater than the weight of an oxy-hydrogen burner, the choice of the lathe carriage 58 and its arrangement with respect to the chucks 48 and 52 may be different than that used for the FIG. 5 apparatus having the MCVD burner. For example, instead of maintaining the workpiece stationary and traversing the plasma torch, as the FIG. 5 apparatus operates, a substitute apparatus may be used which supports the plasma torch in a stationary manner while moving the workpiece back and forth along the axis of rotation. Such an apparatus removes the potential problem of supporting a plasma torch, which is typically heavy, on a lathe carriage.

A plasma torch for the collapsing operation has the advantage of substantially no moisture generation and better control of the heating power.

A further embodiment of the invention uses a plasma torch instead of the oxy-hydrogen burner 60 deposits and consolidates additional silica on the outside of the usable portion of the temporary unitary member 62, namely the deposition section 4, after being installed as described above and prior to the collapsing operation. The deposition can, for example, be carried out using known plasma outside vapor deposition (POVD) methods. The POVD operation may also be termed “overcladding.” The overcladding is preferably pure silica, which does not require precision controlled injection of dopant chemicals. Therefore, the benefit of the collapsing not being performed on an apparatus having a precision chemical source, i.e., the chemical vapor deposition apparatus, is maintained. In addition, the improved efficiency of the invention is maintained as well, with the further benefit of performing overcladding.

While the present invention has been disclosed with reference to certain preferred embodiments, these should not be considered to limit the present invention. One skilled in the art will readily recognize that variations of these embodiments are possible, each falling within the scope of the invention, as set forth in the claims below.

What is claimed:

1. A method for making an optical fiber preform, comprising steps of:
(a) providing a tubular member having a cylindrical outer surface, a cylindrical bore having a longitudinal axis, a first end, a second end opposite said first end, and a deposition section extending in the direction of said longitudinal axis,;
(b) installing said tubular member in a first lathe;
(c) chemical vapor depositing a sintered silica on said cylindrical bore along the deposition section until a predetermined thickness of silica is deposited;
(d) rotating said deposition section having the predetermined thickness of silica on a second lathe;
(e) collapsing said rotating deposition section by heating with a torch to form a preform.

2. A method according to claim 1 wherein said chemical vapor depositing includes plasma chemical vapor depositing.

3. A method according to claim 1 wherein said rotating includes separating a processing length of said tubular member having said deposition section from a remainder of said tubular member and installing said length in said second lathe.

4. A method according to claim 3 wherein said separating includes:
necking down a region of said tubular member to form a closed cylindrical member extending for said processing length and having said deposition section, having a closure at one end and an opening at a second end opposite said one end, and
removing said closed cylindrical member from said remainder of said tubular member.

5. A method according to claim 4 wherein said second lathe includes a first rotatable chuck and a second rotatable chuck, and said rotating in said second lathe includes:
pressurizing said closed cylindrical member by connecting a gas source to said opening at said second end and injecting a pressurization gas;
forming a through hole in said closed end to form an open cylindrical member from said closed cylindrical member;
securing a portion of said open cylindrical member proximal to said opening to said first rotatable chuck; and
securing said second end of said open cylindrical member to said second rotatable chuck.

6. A method according to claim 5 wherein second lathe rotates said open cylindrical member about a second lathe rotational axis, and at least one of said first and second chucks is movable toward and away from the other of said first and second chucks, in an axial direction parallel to said second lathe rotational axis and clampable in a position along said direction, and said securing a portion of said open cylindrical member to said first rotatable chuck includes:
securing a mounting member to said first rotatable chuck;
moving at least one of said first and second chucks to spacing in said axial direction wherein said open cylindrical member can be aligned collinear to said second lathe rotational axis;
aligning said open cylindrical member along said second lathe rotational axis;
securing one end of said open cylindrical member to said second rotatable chuck; and
moving at least one of said first and second chucks toward the other to compress the end of said open cylindrical member proximal to said through hole against said mounting member.

7. A method according to claim 6 wherein said securing a portion of said open cylindrical member to said first rotatable chuck further includes fusing said end of said open cylindrical member proximal to said through hole to said mounting member.

8. A method according to claim 5 wherein said pressurization gas includes a hydrogen scavenging substance.

9. A method according to claim 1 wherein said collapsing includes flowing a pressurization gas through said uncollapsed preform.

10. A method according to claim 9 wherein said collapsing includes maintaining a pressure of said pressurization gas according to:
Pressure=850×(1/Do+1/Di), where
Do=outside tube diameter (millimeters),
Di=inside tube diameter (millimeters),
Pressure=equilibrium pressure in Pascals.

11. A method according to claim 9 wherein said flowing a pressurization gas includes monitoring a pressure of said pressurization gas at an upstream end of said uncollapsed preform and at a downstream end of said uncollapsed preform.

12. A method according to claim 10 wherein said flowing a pressurization gas includes monitoring a pressure of said pressurization gas at an upstream end of said uncollapsed preform and at a downstream end of said uncollapsed preform.

13. A method according to claim 9 wherein said pressurization gas includes a hydrogen scavenging substance.

14. A method according to claim 10 wherein said pressurization gas includes a hydrogen scavenging substance.

15. A method according to claim 13 wherein said hydrogen scavenging substance includes chlorine gas.

16. A method according to claim 14 wherein said hydrogen scavenging substance includes chlorine gas.

17. A method according to claim 3 wherein said depositing is carried out such that excess soot is substantially deposited only along portions of said tubular member within said remainder section.

18. A method according to claim 1 wherein (a) through (c) are repeated on another tubular member concurrent with at least a portion of (d) carried out on said deposition section.

19. A method according to claim 1 wherein said collapsing includes heating with a plasma torch.

20. A method according to claim 18 further comprising depositing substantially pure silica on an outer surface of said deposition section.

21. A method according to claim 1 wherein said collapsing includes a stretching of said rotating deposition section concurrent, at least in part, with said collapsing.

22. A method according to claim 21, wherein said second lathe includes a headstock chuck and a tailstock chuck, one of said tailstock chuck and headstock chuck being movable away from other by a drive, and wherein collapsing is performed by traversing a torch along a length of the rotating deposition section, and wherein said stretching is performed by said drive moving said one of said tailstock chuck and said headstock chuck away from said other of said tailstock chuck and said headstock chuck concurrent, at least in part, with said traversing a torch.

23. A method according to claim 9 wherein said collapsing includes a stretching of said rotating deposition section concurrent, at least in part, with said collapsing.

24. A method according to claim 23, wherein said second lathe includes a headstock chuck and a tailstock chuck, one of said tailstock chuck and headstock chuck being movable away from other by a drive, and wherein collapsing is performed by traversing a torch along a length of the rotating deposition section, and wherein said stretching is performed by said drive moving said one of said tailstock chuck and said headstock chuck away from said other of said tailstock chuck and said headstock chuck concurrent, at least in part, with said traversing a torch.

25. A method according to claim 24 wherein said stretching is performed by said drive moving said one of said tailstock chuck and said headstock chuck away from said other of said tailstock chuck and said headstock chuck concurrent, at least in part, with said traversing a torch in the same direction as said pressurization gas flows through said uncollapsed preform.

26. A method according to claim 25 wherein said drive moves said one of said tailstock chuck and said headstock chuck away from said other of said tailstock chuck and said headstock chuck in accordance with at least one the following:
$$( {OD}_{i}^{2} - {ID}_{i}^{2} ) \times {S}_{b} = ( {OD}_{f}^{2} - {ID}_{f}^{2} ) \times ( {S}_{t} - {S}_{b} ) , \\ {S}_{t} = [ ( \frac{{OD}_{i}^{2} - {ID}_{i}^{2}}{{OD}_{f}^{2} - {ID}_{f}^{2}} ) + 1 ] \times {S}_{b}$$
where
ODᵢ: Outside diameter (mm) before stretching and collapsing,
IDᵢ: Inside diameter (mm) before stretching and collapsing,
OD_{f}: Outside diameter (mm) after stretching and collapsing,
ID_{f}: Inside diameter (mm) after stretching and collapsing,
Sₜ: Speed (mm/min) of the tailstock, and
S_{b}: Speed (mm/min) of the torch.

27. A method according to claim 24 wherein said stretching is performed by said drive moving said one of said tailstock chuck and said headstock chuck away from said other of said tailstock chuck and said headstock chuck concurrent, at least in part, with said traversing a torch in a direction opposite that said pressurization gas flows through said uncollapsed preform.

28. A method according to claim 25 wherein said drive moves said one of said tailstock chuck and said headstock chuck away from said other of said tailstock chuck and said headstock chuck in accordance with at least one the following:
$$( {OD}_{i}^{2} - {ID}_{i}^{2} ) \times {S}_{b} = ( {OD}_{f}^{2} - {ID}_{f}^{2} ) \times ( {S}_{t} + {S}_{b} ) , \\ {S}_{t} = [ ( \frac{{OD}_{i}^{2} - {ID}_{i}^{2}}{{OD}_{f}^{2} - {ID}_{f}^{2}} ) - 1 ] \times {S}_{b}$$
where
ODᵢ: Outside diameter (mm) before stretching and collapsing,
IDᵢ: Inside diameter (mm) before stretching and collapsing,
OD_{f}: Outside diameter (mm) after stretching and collapsing,
ID_{f}: Inside diameter (mm) after stretching and collapsing,
Sₜ: Speed (mm/min) of the tailstock, and
S_{b}: Speed (mm/min) of the torch.

29. A method according to claim 18 wherein said collapsing includes a stretching of said rotating deposition section concurrent, at least in part, with said collapsing.

30. A method according to claim 29, wherein said second lathe includes a headstock chuck and a tailstock chuck, one of said tailstock chuck and headstock chuck being movable away from other by a drive, and wherein collapsing is performed by traversing a torch along a length of the rotating deposition section, and wherein said stretching is performed by said drive moving said one of said tailstock chuck and said headstock chuck away from said other of said tailstock chuck and said headstock chuck concurrent, at least in part, with said traversing a torch.

31. A method for making an optical fiber preform, comprising steps of:
(a) providing a tubular member having a cylindrical outer surface, a cylindrical bore having a longitudinal axis, a first end, a second end opposite said first end, and a deposition section extending in the direction of said longitudinal axis,;
(b) installing said tubular member in a lathe;
(c) chemical vapor depositing a sintered silica on said cylindrical bore along the deposition section until a predetermined thickness of silica is deposited;
(d) collapsing said deposition section on said lathe by heating with a torch to form a preform, wherein said collapsing includes a stretching of said rotating deposition section concurrent, at least in part, with said collapsing.

32. A method according to claim 31, wherein said lathe includes a headstock chuck and a tailstock chuck, one of said tailstock chuck and headstock chuck being movable away from other by a drive, and wherein collapsing is performed by traversing a torch along a length of the rotating deposition section, and wherein said stretching is performed by said drive moving said one of said tailstock chuck and said headstock chuck away from said other of said tailstock chuck and said headstock chuck concurrent, at least in part, with said traversing a torch.

33. A method according to claim 32 wherein said collapsing includes flowing a pressurization gas through said uncollapsed preform.

34. A method according to claim 33 wherein said stretching is performed by said drive moving said one of said tailstock chuck and said headstock chuck away from said other of said tailstock chuck and said headstock chuck concurrent, at least in part, with said traversing a torch in a direction opposite that said pressurization gas flows through said uncollapsed preform.

35. A method according to claim 34 wherein said drive moves said one of said tailstock chuck and said headstock chuck away from said other of said tailstock chuck and said headstock chuck in accordance with at least one the following:
$$( {OD}_{i}^{2} - {ID}_{i}^{2} ) \times {S}_{b} = ( {OD}_{f}^{2} - {ID}_{f}^{2} ) \times ( {S}_{t} + {S}_{b} ) , \\ {S}_{t} = [ ( \frac{{OD}_{i}^{2} - {ID}_{i}^{2}}{{OD}_{f}^{2} - {ID}_{f}^{2}} ) - 1 ] \times {S}_{b}$$
where
ODᵢ: Outside diameter (mm) before stretching and collapsing,
IDᵢ: Inside diameter (mm) before stretching and collapsing,
OD_{f}: Outside diameter (mm) after stretching and collapsing,
ID_{f}: Inside diameter (mm) after stretching and collapsing,
Sₜ: Speed (mm/min) of the tailstock, and
S_{b}: Speed (mm/min) of the torch.

36. A method according to claim 31 wherein said stretching is performed by said drive moving said one of said tailstock chuck and said headstock chuck away from said other of said tailstock chuck and said headstock chuck concurrent, at least in part, with said traversing a torch in the same direction as said pressurization gas flows through said uncollapsed preform.

37. A method according to claim 36 wherein said drive moves said one of said tailstock chuck and said headstock chuck away from said other of said tailstock chuck and said headstock chuck in accordance with at least one the following:
$$( {OD}_{i}^{2} - {ID}_{i}^{2} ) \times {S}_{b} = ( {OD}_{f}^{2} - {ID}_{f}^{2} ) \times ( {S}_{t} - {S}_{b} ) , \\ {S}_{t} = [ ( \frac{{OD}_{i}^{2} - {ID}_{i}^{2}}{{OD}_{f}^{2} - {ID}_{f}^{2}} ) + 1 ] \times {S}_{b}$$
where
ODᵢ: Outside diameter (mm) before stretching and collapsing,
IDᵢ: Inside diameter (mm) before stretching and collapsing,
OD_{f}: Outside diameter (mm) after stretching and collapsing,
ID_{f}: Inside diameter (mm) after stretching and collapsing,
Sₜ: Speed (mm/min) of the tailstock, and
S_{b}: Speed (mm/min) of the torch.

38. A method according to claim 31 wherein said collapsing includes maintaining a pressure of said pressurization gas according to:
Pressure=850×(1/Do+1/Di), where
Do =outside tube diameter (millimeters),
Di =inside tube diameter (millimeters),
Pressure=equilibrium pressure in Pascals.
